(19) United States
(12) Patent Application Publication
(10) Pub. No.: US 2004/0048134 A1
(43) Pub. Date: Mar. 11, 2004

(54) Low-contact-resistance interface structure between separator and carbon material for fuel cell, separator and carbon material used therein, and production method for stainless steel separator for fuel cell

(76) Inventors: Hiroshi Kihira, Futtsu-shi (JP); Michio Kaneko, Futtsu-shi (JP); Satoshi Akamatsu, Futtsu-shi (JP); Hotaka Homma, Futtsu-shi (JP); Takehide Senuma, Futtsu-shi (JP)

Correspondence Address: BAKER & BOTTS, 30 ROCKEFELLER PLAZA, NEW YORK, NY, 10112

(21) Appl. No.: 10/438,708

(22) Filed: May 15, 2003

(30) Foreign Application Priority Data
May 16, 2002 (JP) 2002-142075

(51) Int. Cl. H01M 8/02; B05D 5/12

(52) U.S. Cl. 429/34; 427/115

(57) ABSTRACT

A low-contact-resistance interface structure between a separator and a carbon material for a fuel cell, a carbon material and a separator used in the interface structure, and a method for producing a stainless steel separator for a fuel cell are provided. The low-contact-resistance interface structure may contain a titanium nitride layer 0.1 to 200 μm in thickness between the stainless steel separator and the carbon material contacting therewith. Further, in the method for producing a stainless steel separator that is incorporated in the above interface structure for a fuel cell, a titanium nitride layer 0.1 to 200 μm in thickness is formed on one or both surfaces of a stainless steel containing, in mass, C: 0.0005% to 0.03%, Si: 0.01% to 2%, Mn: 0.01% to 2.5%, S: 0.01% or less, P: 0.03% or less, Cr: 13 to 30%, Ti: 0.05 to 5%, with the balance consisting of Fe and unavoidable impurities. Such formation can be effectuated by applying a nitriding treatment to the stainless steel, in an atmosphere gas containing nitrogen, after the stainless steel is formed into a predetermined shape.

### CROSS-REFERENCE TO RELATED APPLICATION

The present application claims priority under 35 U.S.C. § 119 from Japanese Patent Application No. 2002-142075, filed on May 16, 2002, the entire disclosure of which is incorporated herein by reference.

### FIELD OF THE INVENTION

The present invention relates to an interface structure between a separator and a carbon material used as materials for members of a polymer electrolyte fuel cell that can be used for an automobile operated directly by electric power, a small-scale power generating system or the like. In particular, the present invention relates to a low-contact-resistance interface structure between a separator and a carbon material for a fuel cell, a separator and an electrode that may be used in the structure, and a production method for a stainless steel separator for a fuel cell.

### BACKGROUND INFORMATION

The development of a fuel cell for an electric vehicle has rapidly advanced over the last few years, accelerated by a success in the development of a polymer electrolyte material. Unlike a conventional fuel cell of an alkali type, a phosphoric acid type, a fused carbonate type, a solid electrolyte type and so on, a polymer electrolyte fuel cell may be characterized by using an organic film of a hydrogen-ion selective transmission type as an electrolyte.

The polymer electrolyte fuel cell is a system for generating electric power by using, e.g., pure hydrogen or a hydrogen gas, obtained by reforming alcohols or the like, as fuel and by electrochemically controlling the reaction of the fuel with oxygen in the air. Although a polymer electrolyte film is thin, an electrolyte is fixed therein and, the film may function as an electrolyte as long as the dew point in a fuel cell is properly controlled. Therefore, it is not necessary to use a fluid medium such as an aqueous solution type or fused-salt type electrolyte. As a consequence, this type of the fuel cell can be designed as a compact and simple unit.

Conventional stainless steels for fuel cells may include: (i) a corrosion-resistant stainless steel for a fused carbonate type fuel cell described in Japanese Patent Publication No. H4-247852 (the entire disclosure of which is hereby incorporated herein by reference), (ii) a highly corrosion-resistant steel sheet for a separator of a fused carbonate type fuel cell described in Japanese Patent Publication No. H4-358044 (the entire disclosure of which is hereby incorporated herein by reference), (iii) a stainless steel excellent in corrosion resistance to fused-salt and method for producing the stainless steel described in Japanese Patent Publication No. H7-188870; a stainless steel excellent in resistance to fused carbonate disclosed in Japanese Unexamined Patent Publication No. H8-165546 (the entire disclosure of which is hereby incorporated herein by reference), and (iv) a stainless steel excellent in resistance to corrosion by fused carbonate described in Japanese Patent Publication No. H8-225892 (the entire disclosure of which is hereby incorporated herein by reference).

Because stainless steels for fuel cells operating in a high temperature environment where high corrosion resistance is preferred, materials for a solid electrolyte type fuel cell operating at high temperatures of several hundred degrees Celsius have been described. Such materials include metal materials for a solid electrolyte type fuel cell described in Japanese Patent Publication Nos. H6-264193 and H6-293941 and a ferritic stainless steel disclosed in Japanese Unexamined Patent Publication No. H9-67672 (the entire disclosures of which are hereby incorporated herein by reference).

On the other hand, for component materials of a polymer electrolyte fuel cell operating in a temperature range not exceeding 150° C., carbon-base materials have been used due to the temperature not being extremely high and the corrosion resistance and durability possibly being fully secured in such environment. In consideration of the preferences for a price reduction as well as for the weight and size reductions, the research and development of a stainless steel separator has been active to address such preferences.

A polymer electrolyte fuel cell can be formed by arranging, in layers, (i) catalytic electrodes, each of which consists of carbon particulates and precious metal ultra-fine particulates attached to both the surfaces of a polymer electrolyte film functioning as an electrolyte, (ii) current collectors each of which consists of a felt-like carbon fiber aggregate (a carbon paper), the current collectors having the functions of extracting electric power generated at the catalytic electrodes in the form of an electric current and, at the same time, supplying reactive gasses to the catalytic electrodes, (iii) separators for receiving the electric current from the current collectors and, at the same time, separating two kinds of reactive gasses, one mainly composed of oxygen and the other mainly composed of hydrogen, and a cooling medium, from each other, and (iv) other components.

A carbon material has been used also as such type of the separator. However, considering when installing the fuel cell in an automobile, such fuel cell may be costly, and can be fairly large. To address such disadvantages, the application of a stainless steel to a fuel cell member (such as a separator) has been address according to the present invention.

Japanese Patent Publication Nos. 2000-260439 and 2000-256808, the entire disclosures of which are hereby incorporated herein by reference, describe a specific shape and chemical composition of a stainless steel in the case of using it as a member (e.g., a separator) of a polymer electrolyte fuel cell. However, because the contact resistance between a stainless steel separator and a carbon paper that is used as a current collector is high, the energy efficiency of a fuel cell may be significantly lowered has been pointed out as a problem of a stainless steel separator.

The problem in contact resistance with a carbon paper is particular to a stainless steel, in which the existence of a passivated film having a finite resistance value constitutes the essence of corrosion resistance. However, while the publication—“2001 Annual Progress Report/Fuel Cell for Transportation” which is published by the U.S. Department of Energy—describes a study on improving the corrosion resistance of an Ni-Ti or Fe-Ti alloy by covering the surfaces with TiN when the alloy is used as a bipolar plate, this publication does not address the subject of the contact resistance at a surface of a stainless steel.

Therefore, low-contact-resistance materials for members of a polymer electrolyte fuel cell (which enable the maximization of the energy conversion efficiency of the fuel cell) have been reviewed through the investigation of the contact resistance between materials used.

For example, Japanese Patent Publication No. H10-228914 (the entire disclosure of which is hereby incorporated herein by reference) describes a fuel cell separator produced by: (i) forming bulges composed of a plurality of jogs at the inner periphery portion of the separator by applying press-forming to a SUS304 stainless steel, and then (ii) forming a gold plating layer 0.01 to 0.02 μm in thickness on each end face of the bulged tip side. In another example, Japanese Patent Publication No. 2001-6713 (the entire disclosure of which is hereby incorporated herein by reference) describes a stainless steel, titanium, a separator, and the like, which have a low contact resistance, and are being used for a polymer electrolyte fuel cell, those being characterized by depositing a precious metal or a precious metal alloy on the portion that contacts with another member and develops contact resistance.

In the above two-mentioned Japanese Patent Publications, precious metal is used for lowering contact resistance and, and for further reducing costs and saving rare resources, a method for lowering contact resistance without using a precious metal has been described.

As a measure to avoid the use of a precious metal, Japanese Patent Publication No. 2000-309854 (the entire disclosure of which is hereby incorporated herein by reference) describes a technique for lowering contact resistance by having chromium and carbon in a stainless steel precipitate during annealing and securing electric conduction through the chromium carbide precipitates that have disposed to the surface through a passivated film.

However, such technique has certain problems. In particular, the annealing process of a stainless steel requires too much time and thus the invention entails low productivity and a high production cost. In contrast, if the annealing time is shortened to reduce the production cost, chromium-depleted layers develop metallographically around the periphery of chromium carbide that is precipitated and thus deteriorate corrosion resistance. In addition, while a heavy working process is indispensable for the forming of a separator, if a large amount of chromium carbide precipitates in the metallographic structure before the working is applied, cracks may develop during the working process.

### SUMMARY OF THE INVENTION

It is one of the objects of the present invention is to provide a low-contact-resistance interface structure between a separator and an electrode for a fuel cell, the interface structure making it possible to avoid the use of a precious metal, to form a separator, and to lower contact resistance to a carbon material while corrosion resistance is preferably fully maintained. Another object of the present invention is to provide an electrode and a separator used in the interface structure. Yet another object of the present invention is to provide a method for producing a stainless steel separator for a fuel cell.

Based on the detailed analysis of a low-contact-resistance interface structure between a separator and a carbon material wherein a precious metal was not used, it has been determined that titanium nitride had the effect of lowering contact resistance.

Thus, according to an exemplary embodiment of the present invention, a low-contact-resistance interface structure is provided between a separator and a carbon material for a fuel cell. The structure has a titanium nitride layer 0.1 to 200 μm in thickness between the stainless steel separator, and the carbon material in contact therewith. The titanium nitride layer can be formed on one or both surfaces of the stainless steel separator and/or one or both surfaces of the carbon material. All or a part of the titanium nitride in the titanium nitride layer can be provided in the form of a particulate.

According to another exemplary embodiment of the present invention, a carbon material is provided for a fuel cell. The carbon material may be used as an electrode in a low-contact-resistance interface structure between a separator and an electrode for a fuel cell, which has a titanium nitride layer 0.1 to 200 μm in thickness on the surface contacting with the stainless steel separator.

According to yet another exemplary embodiment of the present invention, a stainless steel separator is provided for a fuel cell. The stainless steel separator can be used in a low-contact-resistance interface structure between a separator and a carbon material for a fuel cell, which has a titanium nitride layer 0.1 to 200 μm in thickness on the surface contacting with the carbon material.

In still another embodiment of the present invention, a method is provided for producing a stainless steel separator for a fuel cell. In this method, a titanium nitride layer 0.1 to 200 μm in thickness is formed on one or both surfaces of a stainless steel which contains, in mass,

C: 0.0005 to 0.03%,

Si: 0.01 to 2%,

Mn: 0.01 to 2.5%,

S: 0.01% or less,

P: 0.03% or less,

Cr: 13 to 30%, and

Ti: 0.05 to 5%,

with the balance consisting of Fe and unavoidable impurities. Such layer can be formed by applying a nitriding treatment to the stainless steel in an atmosphere gas containing nitrogen after the stainless steel is formed into a prescribed shape. The stainless steel may further contain, in mass, one or more of:

Ni: 1 to 25%,

Cu: 0.1 to 3%, and

Mo: 0.1 to 7%.

In addition, the dew point of the atmosphere in the nitriding treatment may be −20° C. or lower, the treatment temperature can be 800° C. to 1,300° C., and the treatment time may be ten seconds to one hour. Further, the atmosphere gas containing nitrogen can be ammonia cracking gas or pure nitrogen.

### DETAILED DESCRIPTION

It is generally considered that the electrical resistance developed at a contact portion between a stainless steel (functioning as a separator) and a carbon material (e.g., a carbon paper, functioning as an electrode) can be caused by an oxide film, referred to as a passivated film, on a surface of the stainless steel. However, it has been determined that the cause is not limited thereto.

In particular, a nonlinear resistance component may be created by the Schottky barrier occurring on the side of a carbon material that is caused by the difference in the Fermi levels between a stainless steel and the carbon material contacting with each other, and the addition of this nonlinear resistance component causes the phenomenon of an abnormally high contact resistance. This means that it is possible to significantly lower contact resistance between a stainless steel and a carbon material by controlling the electronic structure at the contact interface and, by so doing, taking measures to form an interface density level under which the Schottky barrier is mitigated and/or tunneled through. Other intermediate materials, i.e., other than precious metals, can be used existing at the interface between a stainless steel and a carbon material and satisfying the above condition. For example, the presence of titanium nitride can produce such effect.

In practice, one of the most potent measures in obtaining titanium nitride is to form a titanium nitride layer on a surface of a Ti containing stainless steel by applying nitriding treatment to the stainless steel. However, the presence of titanium nitride between the two materials is effective for reducing contact resistance at an interface between a stainless steel and a carbon material. In this sense, it is not always necessary to form titanium nitride on the side of the stainless steel surface. Thus, a sufficient effect can be expected also when titanium nitride is simply deposited on a surface of a carbon material. Further, in the case where titanium nitride deposits or precipitates on the surfaces of both the materials, the effect of lowering the contact resistance can be the largest.

Another effective method (i.e., other than the method of applying nitriding treatment to a surface of a stainless steel sheet) is the application of a titanium nitride powder. Using this method, it is possible to apply the titanium nitride powder to a surface of a stainless steel and/or a carbon material, and possible to a surface of a stainless steel that has already been subjected to the nitriding treatment. A desirable grain size of the powder is #300 or the like. When the powder is too coarse, it may not stick to the surface. On the other hand, when the powder is too fine, it can be difficult to handle owing to agglutination and. In addition, the titanium nitride layer can be uneven. The titanium nitride may be applied either by painting with a brush in the form of powder, or by painting using a volatile solvent in which the powder is dispersed. The titanium nitride powder is easily available in the form of a reagent being approximately 99% pure. A purity higher than 99% is also acceptable. However, even if the purity exceeds 99%, the effect of lowering the contact resistance may not be dramatically enhanced.

The purpose of forming a titanium nitride layer is to introduce a change in an electronic structure at the surface of a carbon material contacting face to face with a stainless steel, and the effect begins to appear when the thickness of the layer reaches 0.1 μm or more. When the thickness is too large, the contact resistance may increases due to the resistance of titanium nitride itself. At the same time, the treatment may need to be implemented for a longer time, thus likely resulting in a cost increase. For this reason, it may be desirable to control the thickness of the layer to 200 μm at the most. As described above, one of the most dominant measures in forming the titanium nitride layer is to form it on a surface of a stainless steel using the nitriding treatment, such that the Ti-containing stainless steel is heated in the atmosphere which contains nitrogen. Such measure is explained below in further detail.

As an initial matter, the chemical components of a stainless steel are explained. The percentage figures are in mass percent. C is known to create a chromium-depleted layer, and thus may deteriorate a corrosion resistance of a stainless steel as chromium carbide precipitates, particularly, at crystal grain boundaries. In addition, solute C is known to anchor dislocations, and thus can deteriorate workability. For these reasons, it may be desirable to reduce the amount of C. However, a complete removal of C at a refining process may need significant expenditures. Based on the above situation, it is preferable for the content of C to be in the range of 0.0005% to 0.03%.

Si may be used as a deoxidizing agent for producing a stainless steel. Thus, Si may be preferably added in the percentage of at least 0.01%. Si also has a positive effect on the stress corrosion cracking susceptibility of an austenitic stainless steel, and thus a percentage thereof can be added, e.g., up to a maximum of 2%, within the range in which formability is not adversely affected.

Mn may preferably be added by a percentage of 0.01% or more for improving hot workability during the production, and may be added, e.g., up to a maximum percentage of 2.5%, for controlling the deoxidizing function, the workability and the percentage of austenite.

S and P are elements which may be detrimental to the corrosion resistance; it may be preferable to reduce their contents. For this reason, the contents of S and P can be 0.01% or less and 0.03% or less, respectively. It may be desirable (from the viewpoint of steelmaking costs) to set the lower limit of the content of each of them at the percentage of 0.001%.

Cr can be the principal element that sustains the corrosion resistance of a stainless steel. Thus, an addition of Cr by at least 13% is preferable. When Cr is added excessively, on the other hand, it can become difficult to process the material, and also to produce it. For this reason, the upper limit of the addition amount of Cr can be set at 30%.

One of the important features of the present invention is that a stainless steel according to the present invention acquires a low contact resistance to carbon by, e.g., (i) forming the stainless steel into the shape of a separator, (ii) subjecting the separator to a nitriding treatment in an atmosphere containing nitrogen, and (iii) by so doing, having Ti contained in the steel precipitate in a small amount on the surface in the form of titanium nitride. Therefore, Ti may be an important additional element for forming the titanium nitride layer according to the present invention. For example, the amount of Ti for obtaining the effect of the present invention should be at least 0.05%. When the addition amount of Ti is over 5%, however, inclusions may precipitate excessively, toughness and other properties can be deteriorated, and it becomes difficult to form a stainless steel into the separator. A desirable range of the addition amount is from 0.1% to 2%.

Ni is an element capable of sustaining corrosion resistance and, at the same time, improving a workability. From the viewpoint of cost, a ferritic stainless steel not containing Ni may be advantageous and, for this reason, it should be added selectively. However, when heavy working is applied, an austenitic stainless steel should be used, and therefore Ni should be added. In addition, when a stainless steel is used as a fuel cell separator, the growth of an oxide film is inhibited and corrosion resistance is enhanced as the Ni content increases. Therefore, the addition of Ni can be desirable. When Ni is added, it should be added to 1% or more. On the other hand, the effects of Ni are virtually saturated with an addition of 25%, and therefore the addition of more than 25% may not necessarily justify the cost. For this reason, the upper limit thereof can be set at 25%.

Cu, similarly to Ni, is also an element that may improve the workability and corrosion resistance. Its effects begin to appear when it is added by 0.1% and, therefore, it should preferably be added by 0.1% or more in a selective manner. However, when Cu is added in excess of 3%, precipitates may be formed, thus possibly causing a problem in the homogeneity of a passivated film, and consequently, the corrosion resistance may deteriorate.

Mo improves corrosion resistance significantly when it is added in combination with Cr. The effect likely begins to appear when it is added by 0.1% and, therefore, Mo should be added by 0.1% or more in a selective manner. However, when Mo is added in excess of 7%, the steel may harden, and can become difficult to process and produce it.

With regard to a high temperature heat treatment for nitriding, any method of surface nitriding may be employed as long as a particular stainless steel separator can be produced, i.e., such separator including a titanium nitride layer 0.1 μm to 200 μm in thickness on the surface contacting with the carbon material. For example, the recommendable conditions of an exemplary method are as follows: (i) the dew point of a treatment atmosphere is −20° C. or lower, (ii) the temperature is 800° C. to 1,300° C., and (iii) the treatment time is in the range from ten seconds to one hour. As an atmosphere gas containing nitrogen, it is preferable to use ammonia cracking gas or pure nitrogen.

In the production processes of a stainless steel other than with the nitriding treatment, it may be desirable to provide titanium in a stainless steel in the form of a solid solution during, e.g., all process steps including steelmaking, hot rolling, pickling of a hot rolled sheet, cold rolling, continuous annealing, pickling for descaling, foil rolling and bright annealing. It is also desirable for the heat treatment to be so applied such that a stainless steel is made as soft as possible during the processes up to the forming of a separator. Thus, it is desirable to subject the stainless steel to annealing in an inert gas atmosphere or bright annealing in a pure hydrogen atmosphere, each of which annealing bearing the condition that C or N is hardly taken into the interior, or the surface of the steel material from the outside thereof until the steel material is formed into a sheet or a foil material.

In addition, there may be a case where a flat sheet or a foil can be used for a separator, and forming does not have to be applied. In such case, it is possible to provide a stainless steel with the function specified in the present invention by properly controlling the atmosphere in a bright annealing furnace that constitutes the final process in the production of the sheet or foil material. A stainless steel sheet or foil thus produced may, at times, be hardened through rolling and/or heat treatment of the material due to the stability of an electric contact point and the springiness.

As described above, the structure, separator carbon material and method according to the present invention may significantly lower the contact resistance of a member without using a precious metal or the like, and thus can contribute to the promotion of the practical use of a polymer electrolyte fuel cell, the contact resistance having been a problem when a stainless material having a lower cost and allowing more intensive compaction than a conventional carbon material is applied to a material for a separator in a polymer electrolyte fuel cell. The fuel cell may be a device that can be used instead of a combustion engine of an automobile or a portable power generator. Provided below are examples according to the present invention, which do not limit the invention or the principles thereof in any manner.

### EXAMPLE 1

Various kinds of stainless steel sheets of, e.g., 2 mm in thickness can be produced under laboratory conditions through the processes of melting, hot rolling, pickling for descaling, cold rolling, and bright annealing in a hydrogen gas flow. Specimens may be prepared by cutting the sheets thus obtained into discs 30 mm in diameter. The nitriding treatment can be carried out in an ammonia cracking gas having a dew point controlled to −30° C., and under a standard condition of 1,100° C. for 60 sec. Some specimens may be treated for longer periods of time for the purpose of determining the upper limit of titanium nitride film thickness.

Contact resistance can be measured by: (i) placing two jigs at the top and bottom, each having a disc-shaped current supplying surface 30 mm in diameter, (ii) between the jigs, sandwiching two disc-shaped gold-plated copper plates 30 mm in diameter and 4 mm in thickness for measuring electric potential, a carbon paper, and a stainless steel sheet 30 mm in diameter and 2 mm in thickness, the stainless steel sheet being the object to be measured, (iii) putting a weight on the top of the pile so that the bearing pressure at the contact surfaces was 7 kg/cm², (iv) applying a constant current having a current density of 1.0 A/cm², and (v) measuring the potential difference between the disc-shaped gold-plated copper plates for measuring electric potential and the stainless steel sheet.

Contact resistance between gold and a carbon paper can be determined by: (i) sandwiching a carbon paper between two disc-shaped gold-plated copper plates, (ii) dividing the potential difference value measured between the two disc-shaped gold-plated copper plates by the current density value, and then (iii) further dividing the dividend by two. Therefore, the resultant contact resistance value includes the resistance value of a half of the thickness of the carbon paper.

Contact resistance between a stainless steel and a carbon paper can be determined by: (i) measuring the potential difference between both the ends of the pile of the stainless steel, the carbon paper and the gold-plated copper plates, (ii) dividing the measured potential difference value by the current density value to obtain the total resistance value, and (iii) subtracting the contact resistance value between the gold and the carbon paper from the total resistance value.

Table 1 shows the results of investigating the relationship between the Ti contents in the stainless steels and the contact resistance reduction effects, with the amounts of chemical components except Ti maintained at the identical levels. “Nitriding” in the column “Treatment” represents the aforementioned nitriding treatment in the atmosphere containing nitrogen. When the Ti content was increased to 0.05% or more, the value of the contact resistance may decrease to 100 mΩcm² or less, and it should be understood that the effect of the present invention are obtained in such manner. As a result of analyzing the surfaces of the sample according to the present invention by ESCA, titanium nitride can be detected in the samples processed through the nitriding treatment in the atmosphere containing nitrogen. The thickness of titanium nitride may be determined by: (i) measuring the distributions of Ti and N in the depth direction through the depth analysis by AES, and (ii) converting the distributions into the thickness of the titanium nitride using a calibration curve based on spattering time. The results are shown in the tables 1-6.

TABLE 1
Measurement results of contact resistance between each of untreated carbon papers and each of various kinds of
stainless steels (verification of titanium content and effect thereof)

| | | | | | | | | | | | TiN | Contact | |
|---|---|---|---|---|---|---|---|---|---|---|---|---|---|
| Steel | Chemical component (in mass %) | | | | | | | | | | thickness | resistance | |
| symbol | C | Si | Mn | P | S | Cr | Ni | Mo | Ti | Treatment | (μm) | (mΩcm²) | Remark |
| N1 | 0.01 | 0.5 | 0.5 | 0.01 | 0.005 | 18.1 | 7.2 | 2.4 | 0.01 | Nitriding | 0.01 | 600 | Comparative |
| | | | | | | | | | | 60 sec. | | | sample |
| N2 | 0.01 | 0.5 | 0.5 | 0.01 | 0.005 | 17.8 | 7.3 | 2.5 | 0.03 | Nitriding | 0.02 | 450 | Comparative |
| | | | | | | | | | | 60 sec. | | | sample |
| N3 | 0.01 | 0.5 | 0.5 | 0.01 | 0.005 | 17.7 | 7.1 | 2.4 | 0.05 | Nitriding | 0.1 | 99 | Invention |
| | | | | | | | | | | 60 sec. | | | sample |
| N4 | 0.01 | 0.5 | 0.5 | 0.01 | 0.005 | 18.2 | 6.9 | 2.3 | 0.1 | Nitriding | 0.15 | 85 | Invention |
| | | | | | | | | | | 60 sec. | | | sample |
| N5 | 0.01 | 0.5 | 0.5 | 0.01 | 0.005 | 18.1 | 7.1 | 2.4 | 0.2 | Nitriding | 1.2 | 75 | Invention |
| | | | | | | | | | | 60 sec. | | | sample |
| N6 | 0.01 | 0.5 | 0.5 | 0.01 | 0.005 | 18.0 | 7.3 | 2.5 | 0.4 | Nitriding | 3.2 | 65 | Invention |
| | | | | | | | | | | 60 sec. | | | sample |
| N7 | 0.01 | 0.5 | 0.5 | 0.01 | 0.005 | 17.7 | 7.2 | 2.6 | 0.5 | Nitriding | 4.5 | 50 | Invention |
| | | | | | | | | | | 60 sec. | | | sample |

Table 2 provides an exemplary list of results of measuring the contact resistance when the titanium nitride films were made to grow intentionally by extending the time of the nitriding treatment in the atmosphere containing nitrogen for the purpose of determining an exemplary upper limit of the thickness of the titanium nitride that allowed the effect the samples according to the present invention to show up while the thickness of the titanium nitride may be increased. It should be understood that the contact resistance began to increase and the effect of the present invention to decrease when the thickness of the titanium nitride can exceed 200 μm.

TABLE 2
Measurement results of contact resistance between each of untreated carbon papers and each of various kinds of
stainless steels (verification of titanium content and effect thereof)

| | | | | | | | | | | | TiN | Contact | |
|---|---|---|---|---|---|---|---|---|---|---|---|---|---|
| Steel | Chemical component (in mass %) | | | | | | | | | | thickness | resistance | |
| symbol | C | Si | Mn | P | S | Cr | Ni | Mo | Ti | Treatment | (μm) | (mΩcm²) | Remark |
| N7 | 0.01 | 0.5 | 0.5 | 0.01 | 0.005 | 17.7 | 7.2 | 2.6 | 0.5 | Nitriding | 45 | 50 | Invention |
| | | | | | | | | | | 600 sec. | | | sample |
| N7 | 0.01 | 0.5 | 0.5 | 0.01 | 0.005 | 17.7 | 7.2 | 2.6 | 0.5 | Nitriding | 100 | 65 | Invention |
| | | | | | | | | | | 1200 sec. | | | sample |
| N7 | 0.01 | 0.5 | 0.5 | 0.01 | 0.005 | 17.7 | 7.2 | 2.6 | 0.5 | Nitriding | 150 | 70 | Invention |
| | | | | | | | | | | 1800 sec. | | | sample |
| N7 | 0.01 | 0.5 | 0.5 | 0.01 | 0.005 | 17.7 | 7.2 | 2.6 | 0.5 | Nitriding | 195 | 95 | Invention |
| | | | | | | | | | | 2400 sec. | | | sample |
| N7 | 0.01 | 0.5 | 0.5 | 0.01 | 0.005 | 17.7 | 7.2 | 2.6 | 0.5 | Nitriding | 250 | 250 | Comparative |
| | | | | | | | | | | 3000 sec. | | | sample |
| N7 | 0.01 | 0.5 | 0.5 | 0.01 | 0.005 | 17.7 | 7.2 | 2.6 | 0.5 | Nitriding | 300 | 290 | Comparative |
| | | | | | | | | | | 3600 sec. | | | sample |
| N7 | 0.01 | 0.5 | 0.5 | 0.01 | 0.005 | 17.7 | 7.2 | 2.6 | 0.5 | Nitriding | 420 | 320 | Comparative |
| | | | | | | | | | | 4200 sec. | | | sample |

Table 3 provides an exemplary list of the results of measuring the contact resistance of the specimens prepared by changing the chemical components of the base materials in wider ranges and not applying nitriding treatment. In the cases where the treatment according to the present invention is not applied, as there is no titanium nitride layer, all the specimens may exhibit very large values of the contact resistance to the carbon paper.

TABLE 3
Measurement results of contact resistance between each of untreated carbon papers and each of various kinds of untreated
stainless steels (comparative sample)

| | | | | | | | | | | | | TiN | Contact | |
|---|---|---|---|---|---|---|---|---|---|---|---|---|---|---|
| Steel | Chemical component (in mass %) | | | | | | | | | | | thickness | resistance | |
| symbol | C | Si | Mn | P | S | Cr | Ni | Cu | Mo | Ti | Treatment | (μm) | (mΩcm²) | Remark |
| F1 | 0.001 | 0.5 | 0.5 | 0.01 | 0.005 | 13 | | | 0 | 0.2 | Untreated | 0 | 502 | Comparative sample |
| F2 | 0.01 | 0.5 | 0.5 | 0.01 | 0.005 | 13 | | | 0 | 0.2 | Untreated | 0 | 604 | Comparative sample |
| F3 | 0.001 | 0.5 | 0.5 | 0.01 | 0.005 | 17 | | | 1.2 | 0.2 | Untreated | 0 | 504 | Comparative sample |
| F4 | 0.01 | 0.5 | 0.5 | 0.01 | 0.005 | 17 | | | 1.2 | 0.2 | Untreated | 0 | 402 | Comparative sample |
| F5 | 0.001 | 2 | 1 | 0.01 | 0.005 | 22 | | | 1.5 | 0.2 | Untreated | 0 | 302 | Comparative sample |
| F6 | 0.01 | 2 | 1 | 0.01 | 0.005 | 22 | | | 1.5 | 0.2 | Untreated | 0 | 406 | Comparative sample |
| F7 | 0.001 | 0.5 | 0.5 | 0.01 | 0.005 | 30 | | | | 0.2 | Untreated | 0 | 504 | Comparative sample |
| F8 | 0.01 | 0.5 | 0.5 | 0.01 | 0.005 | 30 | | | | 0.2 | Untreated | 0 | 604 | Comparative sample |
| A1 | 0.001 | 0.5 | 0.5 | 0.01 | 0.005 | 18 | 8 | | | 0.2 | Untreated | 0 | 600 | Comparative sample |
| A2 | 0.01 | 0.5 | 0.5 | 0.01 | 0.005 | 18 | 8 | | | 0.2 | Untreated | 0 | 588 | Comparative sample |
| A3 | 0.001 | 2 | 1 | 0.01 | 0.005 | 18 | 8 | | | 0.2 | Untreated | 0 | 595 | Comparative sample |
| A4 | 0.01 | 2 | 1 | 0.01 | 0.005 | 18 | 8 | | | 0.2 | Untreated | 0 | 562 | Comparative sample |
| A5 | 0.001 | 0.5 | 0.5 | 0.01 | 0.005 | 18 | 7 | | 2.5 | 0.2 | Untreated | 0 | 528 | Comparative sample |
| A6 | 0.01 | 0.5 | 0.5 | 0.01 | 0.005 | 18 | 7 | | 2.5 | 0.2 | Untreated | 0 | 546 | Comparative sample |
| A7 | 0.001 | 1.5 | 1 | 0.01 | 0.005 | 18 | 7 | | 2.5 | 0.2 | Untreated | 0 | 578 | Comparative sample |
| A8 | 0.01 | 1.5 | 1 | 0.01 | 0.005 | 18 | 7 | | 2.5 | 0.2 | Untreated | 0 | 595 | Comparative sample |
| A9 | 0.001 | 0.5 | 0.5 | 0.01 | 0.005 | 20 | 15 | 1.7 | 3 | 0.2 | Untreated | 0 | 565 | Comparative sample |
| A10 | 0.01 | 0.5 | 0.5 | 0.01 | 0.005 | 20 | 15 | 1.7 | 3 | 0.2 | Untreated | 0 | 574 | Comparative sample |
| A11 | 0.001 | 1 | 0.5 | 0.01 | 0.005 | 20 | 15 | 1.7 | 3 | 0.2 | Untreated | 0 | 622 | Comparative sample |
| A12 | 0.01 | 1 | 0.5 | 0.01 | 0.005 | 20 | 15 | 1.7 | 3 | 0.2 | Untreated | 0 | 601 | Comparative sample |
| A13 | 0.001 | 0.5 | 1 | 0.01 | 0.005 | 20 | 18 | | 6 | 0.2 | Untreated | 0 | 303 | Comparative sample |
| A14 | 0.01 | 0.5 | 1 | 0.01 | 0.005 | 20 | 18 | | 6 | 0.2 | Untreated | 0 | 604 | Comparative sample |
| A15 | 0.001 | 1 | 1 | 0.01 | 0.005 | 20 | 18 | | 6 | 0.2 | Untreated | 0 | 632 | Comparative sample |
| A16 | 0.01 | 1 | 1 | 0.01 | 0.005 | 20 | 18 | | 6 | 0.2 | Untreated | 0 | 644 | Comparative sample |
| A17 | 0.01 | 1 | 1 | 0.01 | 0.005 | 20 | 1.5 | 0.15 | 0.15 | 0.2 | Untreated | 0 | 645 | Comparative sample |
| A18 | 0.01 | 1 | 1 | 0.01 | 0.005 | 20 | 3 | 0.5 | 0.7 | 0.2 | Untreated | 0 | 655 | Comparative sample |
| A19 | 0.01 | 1 | 1 | 0.01 | 0.005 | 20 | 5 | 1.5 | 1.5 | 0.2 | Untreated | 0 | 635 | Comparative sample |
| N1 | 0.01 | 0.5 | 0.5 | 0.01 | 0.005 | 18.1 | 7.2 | | 2.4 | 0.01 | Untreated | 0 | 565 | Comparative sample |
| N2 | 0.01 | 0.5 | 0.5 | 0.01 | 0.005 | 17.8 | 7.3 | | 2.5 | 0.03 | Untreated | 0 | 574 | Comparative sample |
| N3 | 0.01 | 0.5 | 0.5 | 0.01 | 0.005 | 17.7 | 7.1 | | 2.4 | 0.05 | Untreated | 0 | 622 | Comparative sample |
| N4 | 0.01 | 0.5 | 0.5 | 0.01 | 0.005 | 18.2 | 6.9 | | 2.3 | 0.1 | Untreated | 0 | 601 | Comparative sample |
| N5 | 0.01 | 0.5 | 0.5 | 0.01 | 0.005 | 18.1 | 7.1 | | 2.4 | 0.2 | Untreated | 0 | 603 | Comparative sample |
| N6 | 0.01 | 0.5 | 0.5 | 0.01 | 0.005 | 18.0 | 7.3 | | 2.5 | 0.4 | Untreated | 0 | 604 | Comparative sample |
| N7 | 0.01 | 0.5 | 0.5 | 0.01 | 0.005 | 17.7 | 7.2 | | 2.6 | 0.5 | Untreated | 0 | 632 | Comparative sample |

Table 4 provides exemplary results of measuring the contact resistance of the stainless steels to the carbon papers after the stainless steels having the same or substantially the same chemical components as those provided in Table 3 may be subjected to the nitriding treatment in the atmosphere containing nitrogen. It is provided in the table that any of the stainless steels having a Ti content of 0.05% or more may indicate a contact resistance value of 100 mΩcm² or less. A contact resistance lower than the above value is generally preferable in an actual application. However, it is suggested that the contact resistance obtained in the above cases can be improved by further optimizing the conditions of the nitriding treatment.

TABLE 4
Measurement results of contact resistance between each of untreated carbon papers and each of various kinds of stainless
steels after being subjected to high temperature treatment in an atmosphere containing nitrogen

| | | | | | | | | | | | | TiN | Contact | |
|---|---|---|---|---|---|---|---|---|---|---|---|---|---|---|
| Steel | Chemical component (in mass %) | | | | | | | | | | | thickness | resistance | |
| symbol | C | Si | Mn | P | S | Cr | Ni | Cu | Mo | Ti | Treatment | (μm) | (mΩcm²) | Remark |
| F1 | 0.001 | 0.5 | 0.5 | 0.01 | 0.005 | 13 | | | 0 | 0.2 | Nitriding 60 sec. | 1.5 | 55 | Invention sample |
| F2 | 0.01 | 0.5 | 0.5 | 0.01 | 0.005 | 13 | | | 0 | 0.2 | Nitriding 60 sec. | 1.3 | 75 | Invention sample |
| F3 | 0.001 | 0.5 | 0.5 | 0.01 | 0.005 | 17 | | | 1.2 | 0.2 | Nitriding 60 sec. | 1.2 | 65 | Invention sample |
| F4 | 0.01 | 0.5 | 0.5 | 0.01 | 0.005 | 17 | | | 1.2 | 0.2 | Nitriding 60 sec. | 1.5 | 58 | Invention sample |
| F5 | 0.001 | 2 | 1 | 0.01 | 0.005 | 22 | | | 1.5 | 0.2 | Nitriding 60 sec. | 1.3 | 75 | Invention sample |
| F6 | 0.01 | 2 | 1 | 0.01 | 0.005 | 22 | | | 1.5 | 0.2 | Nitriding 60 sec. | 1.4 | 85 | Invention sample |
| F7 | 0.001 | 0.5 | 0.5 | 0.01 | 0.005 | 30 | | | | 0.2 | Nitriding 60 sec. | 1.2 | 65 | Invention sample |
| F8 | 0.01 | 0.5 | 0.5 | 0.01 | 0.005 | 30 | | | | 0.2 | Nitriding 60 sec. | 1.6 | 85 | Invention sample |
| A1 | 0.001 | 0.5 | 0.5 | 0.01 | 0.005 | 18 | 8 | | | 0.2 | Nitriding 60 sec. | 1.3 | 65 | Invention sample |
| A2 | 0.01 | 0.5 | 0.5 | 0.01 | 0.005 | 18 | 8 | | | 0.2 | Nitriding 60 sec. | 1.5 | 75 | Invention sample |
| A3 | 0.001 | 2 | 1 | 0.01 | 0.005 | 18 | 8 | | | 0.2 | Nitriding 60 sec. | 1.4 | 57 | Invention sample |
| A4 | 0.01 | 2 | 1 | 0.01 | 0.005 | 18 | 8 | | | 0.2 | Nitriding 60 sec. | 1.3 | 65 | Invention sample |
| A5 | 0.001 | 0.5 | 0.5 | 0.01 | 0.005 | 18 | 7 | | 2.5 | 0.2 | Nitriding 60 sec. | 1.4 | 45 | Invention sample |
| A6 | 0.01 | 0.5 | 0.5 | 0.01 | 0.005 | 18 | 7 | | 2.5 | 0.2 | Nitriding 60 sec. | 1.1 | 65 | Invention sample |
| A7 | 0.001 | 1.5 | 1 | 0.01 | 0.005 | 18 | 7 | | 2.5 | 0.2 | Nitriding 60 sec. | 1.5 | 85 | Invention sample |
| A8 | 0.01 | 1.5 | 1 | 0.01 | 0.005 | 18 | 7 | | 2.5 | 0.2 | Nitriding 60 sec. | 1.3 | 95 | Invention sample |
| A9 | 0.001 | 0.5 | 0.5 | 0.01 | 0.005 | 20 | 15 | 1.7 | 3 | 0.2 | Nitriding 60 sec. | 1.4 | 65 | Invention sample |
| A10 | 0.01 | 0.5 | 0.5 | 0.01 | 0.005 | 20 | 15 | 1.7 | 3 | 0.2 | Nitriding 60 sec. | 2 | 55 | Invention sample |
| A11 | 0.001 | 1 | 0.5 | 0.01 | 0.005 | 20 | 15 | 1.7 | 3 | 0.2 | Nitriding 60 sec. | 2.1 | 45 | Invention sample |
| A12 | 0.01 | 1 | 0.5 | 0.01 | 0.005 | 20 | 15 | 1.7 | 3 | 0.2 | Nitriding 60 sec. | 1.6 | 85 | Invention sample |
| A13 | 0.001 | 0.5 | 1 | 0.01 | 0.005 | 20 | 18 | | 6 | 0.2 | Nitriding 60 sec. | 1.5 | 75 | Invention sample |
| A14 | 0.01 | 0.5 | 1 | 0.01 | 0.005 | 20 | 18 | | 6 | 0.2 | Nitriding 60 sec. | 1.5 | 48 | Invention sample |
| A15 | 0.001 | 1 | 1 | 0.01 | 0.005 | 20 | 18 | | 6 | 0.2 | Nitriding 60 sec. | 1.3 | 76 | Invention sample |
| A16 | 0.01 | 1 | 1 | 0.01 | 0.005 | 20 | 18 | | 6 | 0.2 | Nitriding 60 sec. | 1.4 | 91 | Invention sample |
| A17 | 0.01 | 1 | 1 | 0.01 | 0.005 | 20 | 1.5 | 0.15 | 0.15 | 0.2 | Nitriding 60 sec. | 1.5 | 78 | Invention sample |
| A18 | 0.01 | 1 | 1 | 0.01 | 0.005 | 20 | 3 | 0.5 | 0.7 | 0.2 | Nitriding 60 sec. | 1.7 | 95 | Invention sample |
| A19 | 0.01 | 1 | 1 | 0.01 | 0.005 | 20 | 5 | 1.5 | 1.5 | 0.2 | Nitriding 60 sec. | 1.6 | 88 | Invention sample |
| N1 | 0.01 | 0.5 | 0.5 | 0.01 | 0.005 | 18.1 | 7.2 | | 2.4 | 0.01 | Nitriding 60 sec. | 0.01 | 600 | Comparative sample |
| N2 | 0.01 | 0.5 | 0.5 | 0.01 | 0.005 | 17.8 | 7.3 | | 2.5 | 0.03 | Nitriding 60 sec. | 0.02 | 450 | Comparative sample |
| N3 | 0.01 | 0.5 | 0.5 | 0.01 | 0.005 | 17.7 | 7.1 | | 2.4 | 0.05 | Nitriding 60 sec. | 0.1 | 99 | Invention sample |
| N4 | 0.01 | 0.5 | 0.5 | 0.01 | 0.005 | 18.2 | 6.9 | | 2.3 | 0.1 | Nitriding 60 sec. | 0.15 | 85 | Invention sample |
| N5 | 0.01 | 0.5 | 0.5 | 0.01 | 0.005 | 18.1 | 7.1 | | 2.4 | 0.2 | Nitriding 60 sec. | 1.2 | 75 | Invention sample |
| N6 | 0.01 | 0.5 | 0.5 | 0.01 | 0.005 | 18.0 | 7.3 | | 2.5 | 0.4 | Nitriding 60 sec. | 3.2 | 65 | Invention sample |
| N7 | 0.01 | 0.5 | 0.5 | 0.01 | 0.005 | 17.7 | 7.2 | | 2.6 | 0.5 | Nitriding 60 sec. | 4.5 | 50 | Invention sample |

Meanwhile, considering the fact that an electronic structure at a surface of a carbon paper may have a significant influence on an increase in contact resistance, there is a possibility that a contact resistance reduction effect can be obtained when titanium nitride is attached to a surface of a carbon paper. Thus, a small amount of #300 titanium nitride powder of 99% purity may be applied to commercially available carbon papers, each of the carbon papers being made to contact with each of the various kinds of stainless steels, and the contact resistance being measured.

Table 5 provides exemplary contact resistance values between the various kinds of stainless steels not subjected to nitriding treatment and the carbon papers to which titanium nitride may be attached (representing the cases where titanium nitride exist on the surfaces of the carbon materials). Table 6 shows provides exemplary contact resistance values between the various kinds of stainless steels subjected to the nitriding treatment in a nitrogen atmosphere and the carbon papers to which titanium nitride may be attached (representing the cases where titanium nitride exist on both the surfaces of the stainless steels and the carbon materials). The tables show that, e.g., all of the cases exhibited the effect of lowering the contact resistance. As seen in Table 6, when titanium nitride is attached to the surface of a carbon paper and a stainless steel containing 0.05% titanium may be subjected to a high temperature treatment in an atmosphere containing nitrogen, a contact resistance value suitable for withstanding practical use can be realized.

TABLE 5
Measurement results of contact resistance between each of carbon papers to which titanium nitride is attached and each of
various kinds of untreated stainless steels (invention sample)

| | | | | | | | | | | | | TiN | Contact | |
|---|---|---|---|---|---|---|---|---|---|---|---|---|---|---|
| Steel | Chemical component (in mass %) | | | | | | | | | | | thickness | resistance | |
| symbol | C | Si | Mn | P | S | Cr | Ni | Cu | Mo | Ti | Treatment | (μm) | (mΩcm²) | Remark |
| F1 | 0.001 | 0.5 | 0.5 | 0.01 | 0.005 | 13 | | | 0 | 0.2 | Untreated | 27 | 12 | Invention sample |
| F2 | 0.01 | 0.5 | 0.5 | 0.01 | 0.005 | 13 | | | 0 | 0.2 | Untreated | 25 | 15 | Invention sample |
| F3 | 0.001 | 0.5 | 0.5 | 0.01 | 0.005 | 17 | | | 1.2 | 0.2 | Untreated | 35 | 16 | Invention sample |
| F4 | 0.01 | 0.5 | 0.5 | 0.01 | 0.005 | 17 | | | 1.2 | 0.2 | Untreated | 36 | 18 | Invention sample |
| F5 | 0.001 | 2 | 1 | 0.01 | 0.005 | 22 | | | 1.5 | 0.2 | Untreated | 31 | 18 | Invention sample |
| F6 | 0.01 | 2 | 1 | 0.01 | 0.005 | 22 | | | 1.5 | 0.2 | Untreated | 25 | 19 | Invention sample |
| F7 | 0.001 | 0.5 | 0.5 | 0.01 | 0.005 | 30 | | | | 0.2 | Untreated | 45 | 12 | Invention sample |
| F8 | 0.01 | 0.5 | 0.5 | 0.01 | 0.005 | 30 | | | | 0.2 | Untreated | 25 | 13 | Invention sample |
| A1 | 0.001 | 0.5 | 0.5 | 0.01 | 0.005 | 18 | 8 | | | 0.2 | Untreated | 36 | 14 | Invention sample |
| A2 | 0.01 | 0.5 | 0.5 | 0.01 | 0.005 | 18 | 8 | | | 0.2 | Untreated | 37 | 15 | Invention sample |
| A3 | 0.001 | 2 | 1 | 0.01 | 0.005 | 18 | 8 | | | 0.2 | Untreated | 45 | 17 | Invention sample |
| A4 | 0.01 | 2 | 1 | 0.01 | 0.005 | 18 | 8 | | | 0.2 | Untreated | 42 | 13 | Invention sample |
| A5 | 0.001 | 0.5 | 0.5 | 0.01 | 0.005 | 18 | 7 | | 2.5 | 0.2 | Untreated | 41 | 15 | Invention sample |
| A6 | 0.01 | 0.5 | 0.5 | 0.01 | 0.005 | 18 | 7 | | 2.5 | 0.2 | Untreated | 45 | 18 | Invention sample |
| A7 | 0.001 | 1.5 | 1 | 0.01 | 0.005 | 18 | 7 | | 2.5 | 0.2 | Untreated | 35 | 17 | Invention sample |
| A8 | 0.01 | 1.5 | 1 | 0.01 | 0.005 | 18 | 7 | | 2.5 | 0.2 | Untreated | 36 | 14 | Invention sample |
| A9 | 0.001 | 0.5 | 0.5 | 0.01 | 0.005 | 20 | 15 | 1.7 | 3 | 0.2 | Untreated | 32 | 16 | Invention sample |
| A10 | 0.01 | 0.5 | 0.5 | 0.01 | 0.005 | 20 | 15 | 1.7 | 3 | 0.2 | Untreated | 37 | 15 | Invention sample |
| A11 | 0.001 | 1 | 0.5 | 0.01 | 0.005 | 20 | 15 | 1.7 | 3 | 0.2 | Untreated | 36 | 13 | Invention sample |
| A12 | 0.01 | 1 | 0.5 | 0.01 | 0.005 | 20 | 15 | 1.7 | 3 | 0.2 | Untreated | 41 | 17 | Invention sample |
| A13 | 0.001 | 0.5 | 1 | 0.01 | 0.005 | 20 | 18 | | 6 | 0.2 | Untreated | 42 | 19 | Invention sample |
| A14 | 0.01 | 0.5 | 1 | 0.01 | 0.005 | 20 | 18 | | 6 | 0.2 | Untreated | 45 | 14 | Invention sample |
| A15 | 0.001 | 1 | 1 | 0.01 | 0.005 | 20 | 18 | | 6 | 0.2 | Untreated | 36 | 12 | Invention sample |
| A16 | 0.01 | 1 | 1 | 0.01 | 0.005 | 20 | 18 | | 6 | 0.2 | Untreated | 35 | 13 | Invention sample |
| A17 | 0.01 | 1 | 1 | 0.01 | 0.005 | 20 | 1.5 | 0.15 | 0.15 | 0.2 | Untreated | 35 | 15 | Invention sample |
| A18 | 0.01 | 1 | 1 | 0.01 | 0.005 | 20 | 3 | 0.5 | 0.7 | 0.2 | Untreated | 36 | 16 | Invention sample |
| A19 | 0.01 | 1 | 1 | 0.01 | 0.005 | 20 | 5 | 1.5 | 1.5 | 0.2 | Untreated | 25 | 13 | Invention sample |
| N1 | 0.01 | 0.5 | 0.5 | 0.01 | 0.005 | 18.1 | 7.2 | | 2.4 | 0.01 | Untreated | 34 | 14 | Invention sample |
| N2 | 0.01 | 0.5 | 0.5 | 0.01 | 0.005 | 17.8 | 7.3 | | 2.5 | 0.03 | Untreated | 36 | 15 | Invention sample |
| N3 | 0.01 | 0.5 | 0.5 | 0.01 | 0.005 | 17.7 | 7.1 | | 2.4 | 0.05 | Untreated | 34 | 12 | Invention sample |
| N4 | 0.01 | 0.5 | 0.5 | 0.01 | 0.005 | 18.2 | 6.9 | | 2.3 | 0.1 | Untreated | 31 | 16 | Invention sample |
| N5 | 0.01 | 0.5 | 0.5 | 0.01 | 0.005 | 18.1 | 7.1 | | 2.4 | 0.2 | Untreated | 35 | 14 | Invention sample |
| N6 | 0.01 | 0.5 | 0.5 | 0.01 | 0.005 | 18.0 | 7.3 | | 2.5 | 0.4 | Untreated | 45 | 15 | Invention sample |
| N7 | 0.01 | 0.5 | 0.5 | 0.01 | 0.005 | 17.7 | 7.2 | | 2.6 | 0.5 | Untreated | 42 | 16 | Invention sample |

TABLE 6
Measurement results of contact resistance between each of carbon papers to which titanium nitride is attached and each of
various kinds of stainless steels after subjected to high temperature treatment in a nitrogen atmosphere (invention sample)

| | | | | | | | | | | | | TiN | Contact | |
|---|---|---|---|---|---|---|---|---|---|---|---|---|---|---|
| Steel | Chemical component (in mass %) | | | | | | | | | | | thickness | resistance | |
| symbol | C | Si | Mn | P | S | Cr | Ni | Cu | Mo | Ti | Treatment | (μm) | (mΩcm²) | Remark |
| F1 | 0.001 | 0.5 | 0.5 | 0.01 | 0.005 | 13 | | | 0 | 0.2 | Nitriding 60 sec. | 28.5 | 8.4 | Invention sample |
| F2 | 0.01 | 0.5 | 0.5 | 0.01 | 0.005 | 13 | | | 0 | 0.2 | Nitriding 60 sec. | 26.3 | 7.5 | Invention sample |
| F3 | 0.001 | 0.5 | 0.5 | 0.01 | 0.005 | 17 | | | 1.2 | 0.2 | Nitriding 60 sec. | 36.2 | 8.5 | Invention sample |
| F4 | 0.01 | 0.5 | 0.5 | 0.01 | 0.005 | 17 | | | 1.2 | 0.2 | Nitriding 60 sec. | 37.5 | 7.5 | Invention sample |
| F5 | 0.001 | 2 | 1 | 0.01 | 0.005 | 22 | | | 1.5 | 0.2 | Nitriding 60 sec. | 32.3 | 8.9 | Invention sample |
| F6 | 0.01 | 2 | 1 | 0.01 | 0.005 | 22 | | | 1.5 | 0.2 | Nitriding 60 sec. | 26.4 | 8.2 | Invention sample |
| F7 | 0.001 | 0.5 | 0.5 | 0.01 | 0.005 | 30 | | | | 0.2 | Nitriding 60 sec. | 46.2 | 7.5 | Invention sample |
| F8 | 0.01 | 0.5 | 0.5 | 0.01 | 0.005 | 30 | | | | 0.2 | Nitriding 60 sec. | 26.6 | 8.2 | Invention sample |
| A1 | 0.001 | 0.5 | 0.5 | 0.01 | 0.005 | 18 | 8 | | | 0.2 | Nitriding 60 sec. | 37.3 | 8.3 | Invention sample |
| A2 | 0.01 | 0.5 | 0.5 | 0.01 | 0.005 | 18 | 8 | | | 0.2 | Nitriding 60 sec. | 38.5 | 8.4 | Invention sample |
| A3 | 0.001 | 2 | 1 | 0.01 | 0.005 | 18 | 8 | | | 0.2 | Nitriding 60 sec. | 46.4 | 8.7 | Invention sample |
| A4 | 0.01 | 2 | 1 | 0.01 | 0.005 | 18 | 8 | | | 0.2 | Nitriding 60 sec. | 43.3 | 8.8 | Invention sample |
| A5 | 0.001 | 0.5 | 0.5 | 0.01 | 0.005 | 18 | 7 | | 2.5 | 0.2 | Nitriding 60 sec. | 42.4 | 8.9 | Invention sample |
| A6 | 0.01 | 0.5 | 0.5 | 0.01 | 0.005 | 18 | 7 | | 2.5 | 0.2 | Nitriding 60 sec. | 46.1 | 8.2 | Invention sample |
| A7 | 0.001 | 1.5 | 1 | 0.01 | 0.005 | 18 | 7 | | 2.5 | 0.2 | Nitriding 60 sec. | 36.5 | 8.1 | Invention sample |
| A8 | 0.01 | 1.5 | 1 | 0.01 | 0.005 | 18 | 7 | | 2.5 | 0.2 | Nitriding 60 sec. | 37.3 | 8.6 | Invention sample |
| A9 | 0.001 | 0.5 | 0.5 | 0.01 | 0.005 | 20 | 15 | 1.7 | 3 | 0.2 | Nitriding 60 sec. | 33.4 | 8.4 | Invention sample |
| A10 | 0.01 | 0.5 | 0.5 | 0.01 | 0.005 | 20 | 15 | 1.7 | 3 | 0.2 | Nitriding 60 sec. | 39 | 8.3 | Invention sample |
| A11 | 0.001 | 1 | 0.5 | 0.01 | 0.005 | 20 | 15 | 1.7 | 3 | 0.2 | Nitriding 60 sec. | 38.1 | 8.2 | Invention sample |
| A12 | 0.01 | 1 | 0.5 | 0.01 | 0.005 | 20 | 15 | 1.7 | 3 | 0.2 | Nitriding 60 sec. | 42.6 | 8.6 | Invention sample |
| A13 | 0.001 | 0.5 | 1 | 0.01 | 0.005 | 20 | 18 | | 6 | 0.2 | Nitriding 60 sec. | 43.5 | 8.7 | Invention sample |
| A14 | 0.01 | 0.5 | 1 | 0.01 | 0.005 | 20 | 18 | | 6 | 0.2 | Nitriding 60 sec. | 46.5 | 7.9 | Invention sample |
| A15 | 0.001 | 1 | 1 | 0.01 | 0.005 | 20 | 18 | | 6 | 0.2 | Nitriding 60 sec. | 37.3 | 6.9 | Invention sample |
| A16 | 0.01 | 1 | 1 | 0.01 | 0.005 | 20 | 18 | | 6 | 0.2 | Nitriding 60 sec. | 36.4 | 7.2 | Invention sample |
| A17 | 0.01 | 1 | 1 | 0.01 | 0.005 | 20 | 1.5 | 0.15 | 0.15 | 0.2 | Nitriding 60 sec. | 36.5 | 15 | Invention sample |
| A18 | 0.01 | 1 | 1 | 0.01 | 0.005 | 20 | 3 | 0.5 | 0.7 | 0.2 | Nitriding 60 sec. | 37.7 | 16 | Invention sample |
| A19 | 0.01 | 1 | 1 | 0.01 | 0.005 | 20 | 5 | 1.5 | 1.5 | 0.2 | Nitriding 60 sec. | 26.6 | 13 | Invention sample |
| N1 | 0.01 | 0.5 | 0.5 | 0.01 | 0.005 | 18.1 | 7.2 | | 2.4 | 0.01 | Nitriding 60 sec. | 34.01 | 14 | Invention sample |
| N2 | 0.01 | 0.5 | 0.5 | 0.01 | 0.005 | 17.8 | 7.3 | | 2.5 | 0.03 | Nitriding 60 sec. | 36.02 | 11 | Invention sample |
| N3 | 0.01 | 0.5 | 0.5 | 0.01 | 0.005 | 17.7 | 7.1 | | 2.4 | 0.05 | Nitriding 60 sec. | 34.1 | 8.9 | Invention sample |
| N4 | 0.01 | 0.5 | 0.5 | 0.01 | 0.005 | 18.2 | 6.9 | | 2.3 | 0.1 | Nitriding 60 sec. | 31.15 | 7.6 | Invention sample |
| N5 | 0.01 | 0.5 | 0.5 | 0.01 | 0.005 | 18.1 | 7.1 | | 2.4 | 0.2 | Nitriding 60 sec. | 36.2 | 7.5 | Invention sample |
| N6 | 0.01 | 0.5 | 0.5 | 0.01 | 0.005 | 18.0 | 7.3 | | 2.5 | 0.4 | Nitriding 60 sec. | 48.2 | 6.5 | Invention sample |
| N7 | 0.01 | 0.5 | 0.5 | 0.01 | 0.005 | 17.7 | 7.2 | | 2.6 | 0.5 | Nitriding 60 sec. | 46.5 | 6.2 | Invention sample |

From the series of the measurement results described above, a low-contact-resistance interface structure is shown as not needing the application of a precious metal, which had previously been required in the conventional samples and methods, could be provided by interposing titanium nitride between a stainless steel and a carbon material contacting therewith.

### EXAMPLE 2

In Example 2, the method and samples according to the present invention may be applied to the structures of actual fuel cells, and the current density in each cell structure can be examined.

The separators may be formed using the stainless steel N5 in Table 1 as the base material. The paste of fine carbon powder containing platinum can be applied to the polymer electrolyte films that are available in the market and dried. The fuel cells may be manufactured from the above materials and using the carbon papers as the current collectors.

The performance of the fuel cells can be verified through the tests, using which pure hydrogen and artificial air (20% 02 and 80% N₂) may be supplied under atmospheric pressure to the hydrogen electrode and the oxygen electrode, respectively, as fuel gasses, each of the fuel cells can be held in a high temperature chamber so that the temperature of the entire cell may be maintained at 90° C., and the electric current flowing outside the cell, in the direction from the positive electrode to the negative electrode, can be measured.

The size of the electrodes used for the tests may be 20×20 mm. The separators used for the tests can be prepared, considering the corrosion resistance, by subjecting the stainless steel foils processed in a thickness of 0.1 mm to press forming, and thus forming grooves and holes that function as the passages of the gasses and the cooling water and by subjecting them to the high temperature treatment in the nitrogen atmosphere as described above.

For comparison, the performance of fuel cells in which stainless steel separators and/or carbon separators not subjected to nitriding treatment can be incorporated may also be examined. The results of the test are provided in Table 7.

TABLE 7
Outline of power generation test results of polymer electrolyte fuel cells, each having a contact interface structure
according to the present invention or that for comparison.

| | Fuel cell structure | | | | | |
|---|---|---|---|---|---|---|
| Fuel cell | | | Separator | Separator | Current density | |
| structure no. | MEA | Carbon paper | material | treatment | at 0.5 V (mA/cm²) | Remark |
| 1 | Standard | Untreated | Carbon | Untreated | 720 | Comparative |
| | | | | | | sample (Target) |
| 2 | Standard | Untreated | Stainless steel | Gold plated | 721 | Comparative |
| | | | (N5) | | | sample (Target) |
| 3 | Standard | Untreated | Stainless steel | Untreated | 62 | Comparative |
| | | | (N5) | | | sample |
| 4 | Standard | Untreated | Stainless steel | Nitriding, | 341 | Invention sample |
| | | | (N5) | 60 sec. | | |
| 5 | Standard | Titanium nitride | Stainless steel | Untreated | 552 | Invention sample |
| | | attached | (N5) | | | |
| 6 | Standard | Titanium nitride | Stainless steel | Nitriding, | 715 | Invention sample |
| | | attached | (N5) | 60 sec. | | |

In the cases of the fuel cell structure No. 1, in which carbon separators may be used, and the fuel cell structure No. 2, in which gold-plated stainless steel separators can be used, the current densities of 720 and 721 mA/cm² may be obtained, respectively, when an electromotive voltage of 0.5 V is imposed, the two types of structures being regarded as the standards in conventional technologies. The above current densities can be used as the reference figures indicating a target performance.

In the case of the fuel cell structure No. 3, in which the fuel cell may be constructed using untreated stainless steel separators and untreated carbon papers, the resultant current density can be as small as 62 mA/cm². The value constituted a reference figure embodying the problems of the conventional technologies.

The fuel cell structure No. 4 may provide the case indicating the result of investigating the effect of the high temperature treatment in a nitrogen atmosphere on the stainless steel separators according to the present invention, and the resultant current density may be 341 mA/cm².

The fuel cell structure No. 5 may provide the case indicating the result of investigating the effect of the titanium nitride deposition on the carbon papers according to the present invention, and the resultant current density can be 552 mA/cm²

The fuel cell structure No. 6 may provide the case indicating the result of the combined effects of the high temperature treatment in a nitrogen atmosphere on the stainless steel separators according to the present invention, and of the titanium nitride deposition on the carbon papers according to the present invention. The resultant current density may be 715 mA/cm². This indicated that a target performance comparable to the carbon separator and to the gold-plated separator can be virtually achieved.

What is claimed is:

1. A low-contact-resistance interface structure configured to be provided between a stainless steel separator and a carbon material for a fuel cell, comprising:
a titanium nitride layer having a thickness of approximately 0.1 μm to 200 μm in at least one section that is between the stainless steel separator and the carbon material that is contacted by the titanium nitride layer.

2. The low-contact-resistance interface structure according to claim 1, wherein the stainless steel separator has first surfaces, wherein the carbon material has second surfaces, and wherein the titanium nitride layer is formed on one of:
at least one of the first surfaces of the stainless steel separator, and
at least one of the second surfaces of the carbon material.

3. The low-contact-resistance interface structure according to claim 1, wherein the titanium nitride layer includes titanium nitride, and wherein at least one part of titanium nitride is provided in a form of a particulate.

4. A carbon material for a fuel cell, the carbon material configured to be used in a low-contact-resistance interface structure configured to be provided between a stainless steel separator and an electrode for a fuel cell, the low-contact-resistance interface structure comprising a titanium nitride layer having a thickness of approximately 0.1 μm to 200 μm on a surface contacting the stainless steel separator.

5. The carbon material according to claim 4, wherein the stainless steel separator has first surfaces, wherein the carbon material has second surfaces, and wherein the titanium nitride layer is formed on one of:
at least one of the first surfaces of the stainless steel separator, and
at least one of the second surfaces of the carbon material.

6. The carbon material according to claim 4, wherein the titanium nitride layer includes titanium nitride, and wherein at least one part of titanium nitride is provided in a form of a particulate.

7. A stainless steel separator for a fuel cell, the stainless steel separator being used in a low-contact-resistance interface structure configured to be provided between a separator and a carbon material for a fuel cell, the low-contact-resistance interface structure comprising a titanium nitride layer having a thickness of approximately 0.1 μm to 200 μm on a surface contacting with the carbon material.

8. The stainless steel separator according to claim 7, wherein the stainless steel separator has first surfaces, wherein the carbon material has second surfaces, and wherein the titanium nitride layer is formed on one of:
at least one of the first surfaces of the stainless steel separator, and at least one of the second surfaces of the carbon material.

9. The stainless steel separator according to claim 7, wherein the titanium nitride layer includes titanium nitride, and wherein at least one part of titanium nitride is provided in a form of a particulate.

10. A method for producing a stainless steel separator for a fuel cell, comprising the steps of:
(a) shaping a stainless steel into a predetermined shape; and
(b) forming a titanium nitride layer which has a thickness of 0.1 μm to 200 μm on at least one of surfaces of the stainless steel which contains, by mass, approximately:
C: 0.0005% to 0.03%,
Si: 0.01% to 2%,
Mn: 0.01% to 2.5%,
S: 0.01% or less,
P: 0.03% or less,
Cr: 13% to 30%,
Ti: 0.05% to 5%, and
a balance consisting of Fe and unavoidable impurities,
wherein the titanium nitride layer is formed by applying a nitriding treatment to the stainless steel in an atmosphere gas containing nitrogen after step (a).

11. The method according to claim 10, wherein the stainless steel further contains, in mass, approximately one or more of:
Ni: 1% to 25%,
Cu: 0.1% to 3%, and
Mo: 0.1% to 7%.

12. The method according to claim 10, wherein a dew point of the atmosphere gas in the nitriding treatment is at most approximately −20° C., wherein a temperature of the nitriding treatment is approximately 800° C. to 1,300° C., and wherein a time for applying the nitriding treatment is ten seconds to one hour.

13. The method according to claim 10, wherein the atmosphere gas containing nitrogen is one of an ammonia cracking gas and a pure nitrogen.
